(19) United States
(12) Patent Application Publication
(10) Pub. No.: US 2005/0089826 A1
(43) Pub. Date: Apr. 28, 2005

(54) User support management apparatus, user support management program, and user support management program storage medium

(75) Inventors: Shigeru Hidesawa, Kawasaki (JP); Kazuhiko Nakamura, Inagi (JP); Rikiya Naito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited of Kawasaki

(21) Appl. No.: 10/974,915

(22) Filed: Oct. 28, 2004

Related U.S. Application Data
(63) Continuation of application No. PCT/JP02/08514, filed on Sep. 23, 2002.

(51) Int. Cl. G09B 19/00

(52) U.S. Cl. 434/118

(57) ABSTRACT

The present invention relates to a user support management apparatus and the like that manages support for a user who utilizes an object of support such as a personal computer connected thereto via a communication line, and has an object of handling users' trouble appropriately considering the skill level of the user operating the object of support. The user support management apparatus has a user information acquisition section obtaining the skill level of a user operating the object of support and a user information storage section storing skill level obtained by the user information acquisition section in association with the user.

### TECHNICAL FIELD

The present invention relates to a user support management apparatus managing support for a user who utilizes an object of support such as a personal computer and the like that is connected thereto via a communication line, a user support management program that is executed in an information processing apparatus executing programs to cause the information processing apparatus to function as the user support management apparatus, and a user support management program storage medium having the user support management program stored thereon.

### BACKGROUND ART

After purchasing a personal computer (hereinafter sometimes abbreviated to “PC”), a user, especially a novice user, often consults the vender about the basic functions and operations of the PC as such a user does not have sufficient knowledge and experience with PC. Elementary questions made by such novice users are often about matters that would not be asked by users who have a certain degree of experience and knowledge. Today's systems provided by venders (supporters) allow users to ask about such information that could be gained without bothering to inquire of a support desk, which can lay a burden on operators of those systems. When a user cannot get a solution that he/she wants in an inquiry, feeling of insecurity due to the user's inexperience with a PC might lead to distrust in the vender even if the user could not get a solution because of his/her insufficient experience and knowledge.

Some venders provide PC schools that teach beginners how to operate a PC, however, it would not be easy to achieve as much effect as operational expenses due to a number of difficulties such as securing of locations and temporal limitation for running such schools, personnel cost, and training of instructors themselves.

As a problem with the supporting side, the level of knowledge about a PC of a user (questioner) who actually consults them is not known and it can take much time to ascertain how much understanding of PC the user has. Especially in the case of a novice user who believes him/herself to be an advanced user, a person assigned to the user (hereinafter sometimes referred to as a “supporter”) will have great difficulty in handling the user's trouble.

Such difficulty in providing services appropriate for a user can discourage automation of user support.

### DISCLOSURE OF THE INVENTION

In view of such situation as outlined above, the present invention has an object of providing a user support management apparatus that can give support appropriate for the skill level of a user who operates an object of support, a user support management program that realizes the user support management apparatus, and a user support management program storage medium that has stored thereon the user support management program.

The user support management apparatus of the present invention that attains the above object has:
a user information acquisition section that obtains the skill level of a user with respect to an object of support; and
a user information storage section that stores the skill level obtained by the user information acquisition section in association with the user.

The user information acquisition section preferably obtains skill level that is evaluated based on the result of instruction on the object of support received by the user.

Specifically, the user information acquisition section may receive the result of instruction on the object of support received by the user and evaluate the user's skill level based on the result so as to acquire the user's skill level, for example. In that case, the user information acquisition section may also send instructional material relating to an object of support to the object of support employed by the user, and receive the result of instruction received by the user using the instructional material.

Alternatively, the user information acquisition section may send to an object of support both instructional material on the object of support and a scheme that evaluates the result of instruction with the material to determine the user's skill level, and receive the user's skill level that has been determined in the object of support based on the result of instruction received by the user with the instructional material.

The user information acquisition section also preferably obtains skill levels for separate fields on an object of support, and the user information storage section preferably stores skill levels for separate fields obtained by the user information acquisition section in association with the user.

The user information acquisition section also preferably causes the user information storage section to store obtained skill level in association with the user, obtains points newly acquired by the user and adds the acquired points to the remaining points of the user, and causes the user information storage section to store the total points in association with the user. Further, the user information acquisition section preferably obtains information on point consumption, and updates the points stored in the user information storage section of a user who has consumed points to points that is reduced by the consumed points.

In this context, the user information acquisition section preferably obtains points that the user has acquired in accordance with the result of receiving instruction on the object of support.

Specifically, the user information acquisition section may receive the result of the instruction on the object of support received by the user, and calculate the points acquired by the user based on the result so that it obtains the points the user has acquired. In that case, the user information acquisition section may send instructional material on the object of support to the object of support and receive the result of instruction received by the user of the object of support with the instructional material.

Alternatively, the user information acquisition section may send to an object of support both instructional material on the object of support and a scheme that calculates acquired points based on the result of instruction received by the user with the instructional material, and receive the points acquired by the user that has been calculated in the object of support based on the result of instruction received by the user of the object of support with the instructional material.

Further, the user support management apparatus of the present invention preferably has an information provision section that provides an object of support with information appropriate for the skill level of the user of the object of support.

Further, the user support management apparatus of the present invention preferably has a support request accepting section that accepts a request for support from a user and indicates the acceptance of the support request to a supporter machine that is operated by a supporter responsible for user support along with information on the skill level of the requesting user.

In this context, the support request accepting section may also accept the request for support from a user only when the user's skill level is above a certain skill level, or alternatively, it may recommend the user to receive instruction when the user makes a request for support, and accept the request if the user still requests support.

The user support management apparatus may be connected to a communication line and manage an object of support that is connected thereto via the communication line.

The user support management program of the present invention that attains the above object is a user support management program that is executed in an information processing apparatus executing programs to cause the information processing apparatus to operate as a user support management apparatus, and includes all aspects that causes the information processing apparatus to operate as the user support management apparatus having the various aspects described above.

The user support management program storage medium of the present invention that attains the above object is a user support management program storage medium that has stored thereon a user support management program that is executed in an information processing apparatus executing programs to cause the information processing apparatus to operate as a user support management apparatus, and includes all user support management program storage media that stores all user support management programs of all aspects that causes the information processing apparatus to operate as the user support management apparatus having the various aspects as described above.

The “object of support” used herein is not specifically limited, but may be the hardware of a user machine, software such as an OS (operating system) and application programs, both of hardware and software, or only a particular application program.

### BRIEF DESCRIPTION OF THE DRAWINGS

FIG. 1 shows a network configuration that includes an embodiment of the user support management apparatus of the present invention.

FIG. 2 is an outer perspective view of the server machine shown in FIG. 1 that operates as the user support management apparatus of the present invention.

FIG. 3 illustrates a hardware configuration of the server machine that has the appearance shown in FIG. 2.

FIG. 4 generally shows an embodiment of the user support management program of the present invention.

FIG. 5 is a block diagram generally showing an embodiment of the user support management apparatus of the present invention.

FIG. 6 shown an example of user information.

FIG. 7 generally shows the examination DB shown in FIG. 1.

FIG. 8 shows an operational flow of the user-machine.

FIG. 9 shows an operational flow of the supporter machine.

FIG. 10 shows an operational flow of the server machine.

FIG. 11 shows an operational flow of the server machine.

FIG. 12 shows an operational flow of the server machine.

FIG. 13 shows an operational flow of suggesting products to the user machine by the server machine.

FIG. 14 shows an example of user information.

FIG. 15 generally shows the examination DB shown in FIG. 1.

FIG. 16 shows an operational flow of the user machine.

FIG. 17 shows an operational flow of the user machine.

FIG. 18 illustrates the difference of a variation of the operational flow of the user machine described with reference to FIGS. 16 and 17 from the flows of FIGS. 16 and 17.

FIG. 19 shows an operational flow of the supporter machine.

FIG. 20 shows an operational flow of the server machine.

FIG. 21 shows an operational flow of the server machine.

FIG. 22 shows an operational flow of the server machine.

FIG. 23 shows an operational flow of suggesting products to the user machine by the server machine.

### BEST MODE FOR CARRYING OUT THE INVENTION

The user support management apparatus of the present invention is suitable for use as follows, for example.

Within a members-only web site built on a network operated by a vender, an instruction site that gives instructions on PCs manufactured by the vender is provided. The instruction gives comprehensible description on basic concepts and usage of PCs, attempting to improve. users'technical level by providing simple certification tests for the users to clear, and also allowing the vender (supporter) to ascertain how much skill a user has acquired. It may be also possible that users can get points exchangeable for some benefit if they get the instruction.

Technical level and points acquired by a user is managed along with user information (the user's registered ID).

The simple tests can be carried out in any of many ways, including an electronic learning means such as questions accessible on the WEB, and a practical examination in which a user performs a required operation (processing) at a specified time under the supervision of an instructor. These tests are essentially provided as a free service.

Consequently, it is expected that users (especially novice ones) continue to participate in the instructions to get certification of a higher level with the intention of improving their technical level or earning more benefit points.

Such improvement in novice users' technical skills not only benefit the users themselves but can provide significant advantages both for operational efficiency of support and service providers and enhancement of quality of services received by the users, as will be demonstrated later.

For example, a user support desk can promptly determine whether a consulting user is a user who has got technical level certification from the instruction site, and if the user is, the supporter can respond to the user in consideration of the level of the user's technical skill and comprehension.

“Frequently Asked Questions,” which is information provided over the Internet and the like, can identify the user and provide the user with questions often asked by those of the similar skill level and their answers based on the technical level information given to the user by the instruction site. It is also possible to automatically determine the way of description optimum for the technical level of the user, e.g., to utilize many illustrations and to describe procedure steps one by one for a novice user, or to propose an advanced usage to a user of a higher level, thereby giving more satisfaction to the users.

A “part shop”, which sells hardware and software via the Internet, can identify a user and show items best for the user preferentially in accordance with the level information given to the user by the instruction site.

Further, in addition to those who have already purchased a PC, those who are thinking of buying one may register with the members-only site, and a member whose skill is ascertained to have reached a certain level through instruction can be given a benefit of purchasing a PC at a discounted price using the points the user has acquired, which can facilitate the sale of PCs. In this context, by limiting some or all of the scope of service involving high cost for support providers such as telephone support and giving users benefit of buying a PC at a discounted price, purchasers who have acquired skill exceeding a certain level can get the benefit of receiving a discount in exchange for not utilizing basic-level services, while support providers get an advantage of reduced costs of providing support.

Embodiments of the present invention will be now described.

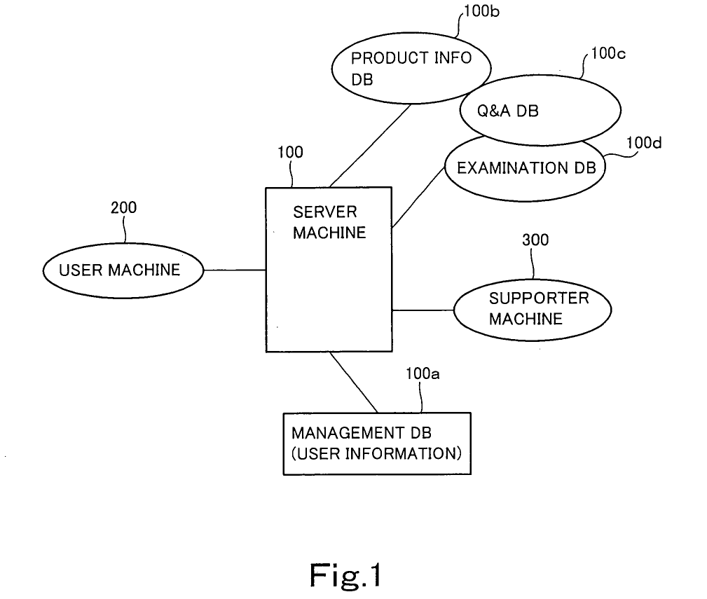

FIG. 1 illustrates a network configuration that includes an embodiment of the user support management apparatus of the present invention.

A server machine 100, a user machine 200, and a supporter machine 300 are deployed, being interconnected by a communication line such as the Internet. The server machine 100 functions as an embodiment of the user support management apparatus of the present invention, managing management database 100a, product information DB (database) 100b, Q&A DB 100c, and examination DB 100d. The management database 100a stores user information having various pieces of information on a user who operates the user machine 200; the product information DB 100b stores information on various products; the Q&A DB 100c stores typical questions about the user machine 200 (Q) and their answers (A); and the examination DB 100d stores questions and answers that determine the user's skill level with respect to the user machine 200.

The user machine 200 may be a machine such as a PC operated by the user, and the supporter machine 300 may be a machine such as a PC operated by a supporter who answers the user's questions about the user machine 200. Although for the sake of clarity only one user machine 200 and only one supporter machine 300 are illustrated, a number of user machines 200 managed by users are typically connected to the server machine 100 via a communication line, and also multiple supporter machines 300 are prepared when there are multiple supporters.

The present invention is characterized by the server machine 100 and programs running in the server machine 100 and the like, it will be thus described mainly in the context of the server machine 100.

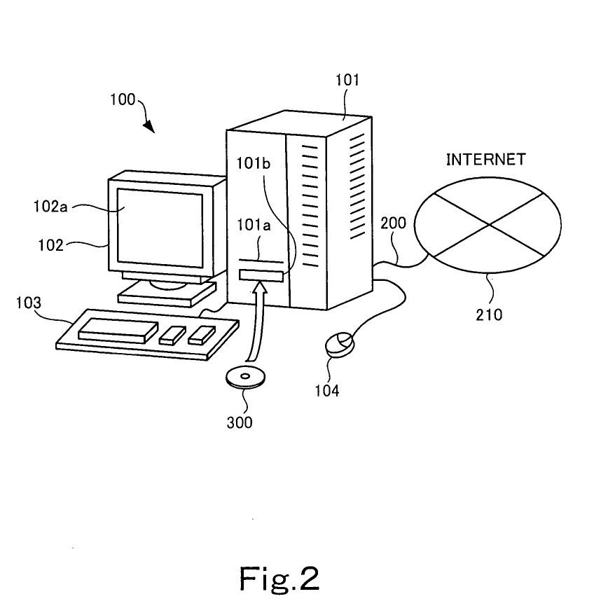

FIG. 2 is an outer perspective view of the server machine 100 shown in FIG. 1 that operates as the user support management apparatus of the present invention.

The server machine 100 is in a form of a computer, including a main unit section 101 that includes therein a CPU (central processing unit), RAM (random access memory), a hard disk, a communication board and the like, a display section 102 that displays images and characters on a display screen 102a in accordance with directions from the main unit section 101, a keyboard 103 that inputs directions from an operator into the server machine 100, and a mouse 104 that specifies a location on the display screen 102a to input directions corresponding to an icon and the like that is displayed at the location at the time of specification.

On its outside, the main unit section 101 further has a FD loading slot 101a and a CD-ROM loading slot 101b that inserts a flexible disk (not shown) and a CD-ROM 300, respectively, and within the loading slots, FD and CD-ROM drives are also included for driving and accessing the flexible disk (FD) and CD-ROM 300 inserted from their respective loading slots 101a and 101b.

The server machine 100 is connected via a communication cable 200 to a communication line 210, which transmits information by way of the Internet. To the communication line 210, a large number of user machines managed by the server machine 100 and multiple supporter machines are connected (not shown).

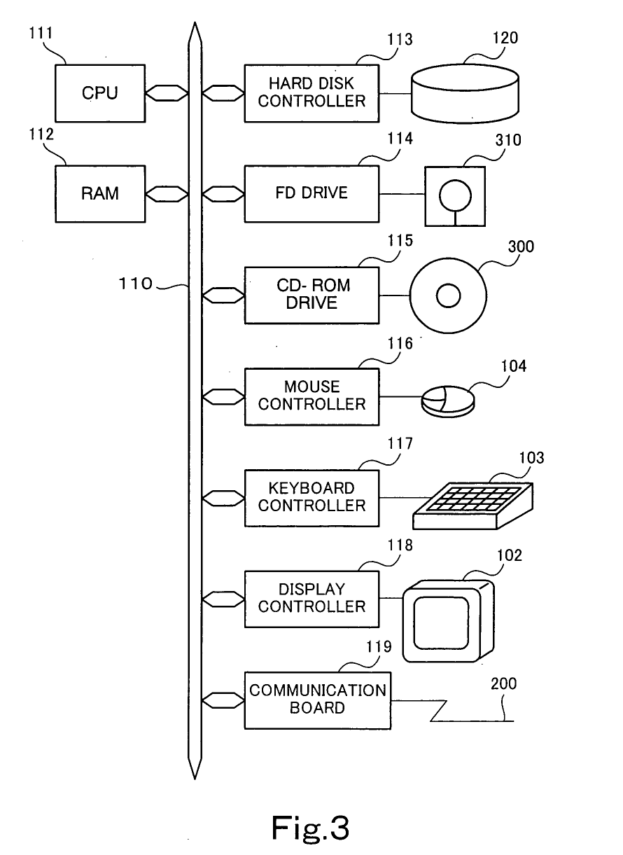

FIG. 3 shows a hardware configuration of the server machine that has the appearance shown in FIG. 2.

Illustrated in this hardware configuration diagram are CPU 111, RAM 112, hard disk controller 113, FD drive 114, CD-ROM drive 115, mouse controller 116, keyboard controller 117, display controller 118, and communication board 119 with the ability of Internet communication, which are interconnected by a bus 110.

The FD drive 114 and CD-ROM drive 115 are for accessing the FD 310 and CD-ROM 300 inserted from the FD loading slot 101a and CD-ROM loading slot 101b respectively, as described with reference to FIG. 2. The communication board 119 is connected to the Internet communication line 210 (see FIG. 2) via the communication cable 200.

Although the communication line 210 is described as an Internet communication line in the present embodiment, the communication line 210 in the present invention is not limited to an Internet communication line but may be a LAN (Local Area Network) and other types of communication line.

FIG. 3 also shows a hard disk 120 accessed by the hard disk controller 113, mouse 104 controlled by the mouse controller 116, keyboard 103 controlled by the keyboard controller 117, and CRT display 102 controlled by the display controller 118.

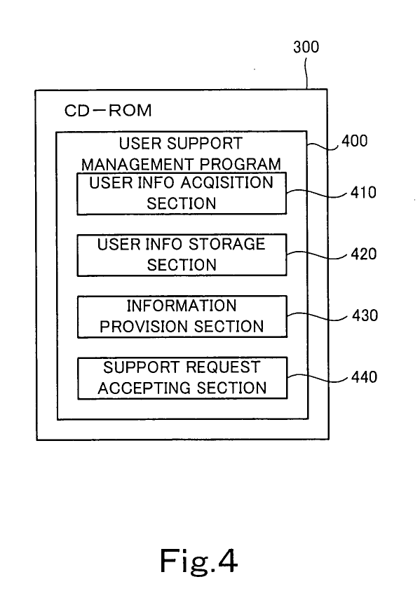

FIG. 4 illustrates a schematic view generally showing an embodiment of the user support management program of the present invention.

The user support management program 400 is stored on the CD-ROM 300, which is inserted through the CD-ROM loading slot 101b shown in FIG. 2 and accessed by the CD-ROM drive 115 of FIG. 3 so that the user support management program 400 stored on the CD-ROM 300 is installed on the server machine 100 shown in FIGS. 2 and 3. When the user support management program installed on the server machine 100 is executed therein, the server machine 100 operates as an embodiment of the user support management apparatus of the present invention.

While the user support management program 400 is described as stored on the CD-ROM 300, it need not be stored on a CD-ROM: it may be stored on a portable storage medium of other types such as a FD and installed onto the server machine 100, may be installed on the server machine 100 from another apparatus and the like via the communication line 210, or stored on the hard disk 120 of the server machine 100 (see FIG. 3) in advance. It thus may be saved or stored in any way as long as it can be eventually executed in the server machine.

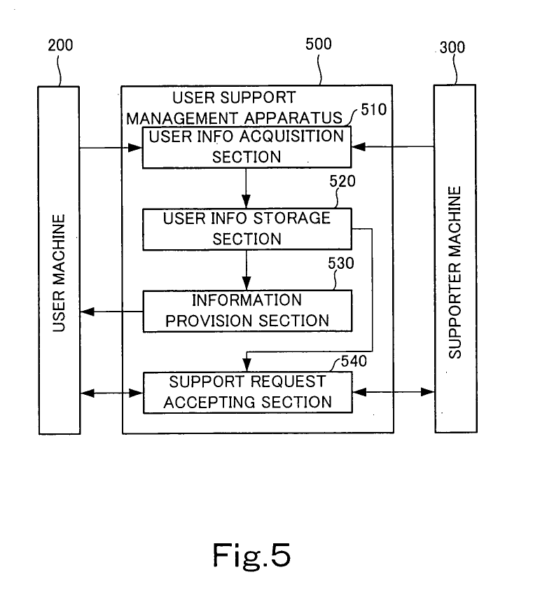

The user support management program 400 of FIG. 4 includes user information acquisition section 410, user information storage section 420, information provision section 430, and support request accepting section 440. The operation of these sections 410 to 440 will be described along with the description of FIG. 5.

FIG. 5 is a block diagram generally showing an embodiment of the user support management apparatus of the present invention.

The user support management apparatus 500 is realized within the server machine 100 shown in FIGS. 1 to 3 by the user support management program 400 of FIG. 4 being executed in the server machine 100 of FIGS. 1 to 3.

The user support management apparatus 500 shown in FIG. 5 includes user information acquisition section 510, user information storage section 520, information provision section 530, and support request accepting section 540. Each of the sections 510 to 540 corresponds to each of the sections 410 to 440 of the user support management program 400 shown in FIG. 4. However, while the sections 510 to 540 constituting the user support management apparatus 500 of FIG. 5 are composed of the combination of the hardware of the server machine 100 shown in FIGS. 1 to 3, an operating system (OS) running on the server machine 100, and the user support management program 400 of FIG. 4 running on the OS, the sections 410 to 440 constituting the user support management program 400 of FIG. 4 are composed only of application programs out of the combination. The operation performed by each of the sections 410 to 440 of the user support management program 400 shown in FIG. 4 when the user support management program 400 is executed in the server machine 100 of FIGS. 1 to 3 is exactly the operation of each of the sections 510 to 540 constituting the user support management apparatus 500 of FIG. 5. Thus, the description of the operation of the sections 510 to 540 constituting the user support management apparatus 500 will also serve as that of the sections 410 to 440 of the user support management program 400 of FIG. 4.

The user support management apparatus 500 shown in FIG. 5 manages the user machine 200 connected with the apparatus 500 via the Internet communication line, and includes the user information acquisition section 510, user information storage section 520, information provision section 530, and support request accepting section 540.

The user information acquisition section 510 is essentially a functional portion that obtains skill level with respect to the user machine 200 of a user operating the machine, and skill level obtained by the user information acquisition section 510 is stored in the user information storage section 520 in association with the user.

The user information acquisition section 510 obtains skill level that has been evaluated based on the result of instruction on the user machine 200 received by the user of the user machine 200. Specifically, the user information acquisition section 510 receives the result of instruction on the user machine that the user has received and evaluates the user's skill level based on the result so that it acquires the user's skill level. Before the user information acquisition section 510 gets the result of the user's instruction, instructional material the user works with may be stored in the user machine 200 in advance, or the user information acquisition section 510 may send instructional material relating to the user machine 200 to the user machine 200.

Alternatively, the user information acquisition section 510 may send to a user machine instructional material about the user machine along with a scheme that evaluates the result of instruction with the material to determine the user's skill level, and receive the user's skill level that has been determined by the user machine based on the result of the user's learning with the material.

The user information acquisition section 510 may also receive skill level for separate fields on the user machine 200, and the user information storage section 520 may store skill level for the separate fields obtained by the user information acquisition section 510 in association with the user.

In addition to obtaining the user's skill level and storing it in the user information storage section 520 in association with the user, the user information acquisition section 510 in the present embodiment obtains points newly acquired by the user, adds the points to the user's remaining points, and stores the total points in the user information storage section 520 in association with the user. The user information acquisition section 510 further obtains information on point consumption, and updates the points stored in the user information storage section 520 of a user who has consumed some points to points that is reduced by the consumed points.

In this context, the user information acquisition section 510 obtains points that the user of the user machine has got in accordance with the result of the user's receiving some instruction on the user machine. Specifically, the user information acquisition section 510 obtains the result of instruction on the user machine received by the user of the user machine, and calculates the points the user gets based on the result so that it obtains the points acquired by the user. Before the user information acquisition section 510 receives the result, instructional material may be stored in the user machine 200 in advance as mentioned above, or, alternatively, the user information acquisition section 510 may send instructional material on a user machine to the user machine and receive the result of instruction received by the user of the user machine with the material.

Alternatively, the user information acquisition section 510 may send to the user machine instructional material on the user machine together with a scheme that calculates points the user gets based on the result of instruction received by the user with the material, and receive the points acquired by the user that has been calculated in the user machine based on the result of the user's learning with the material.

The information provision section 530 of the user support management apparatus 500 shown in FIG. 5 provides the user machine 200 with information appropriate for the skill level of its user. For example, the information provision section 530 provides product information appropriate for the user's skill level to the user machine 200 with reference to the product information DB 100b of FIG. 1, or it provides Q&As (a list of corresponding questions and answers) to the user machine 200 that are appropriate for the user's skill level with reference to the Q&A DB 100c.

The support request accepting section 540 of the user support management apparatus 500 of FIG. 5 accepts a request for support from a user, and indicates the acceptance of the request to the supporter machine 300 operated by a supporter servicing user support along with information on the requesting user's skill level. The support request accepting section 540 may accept a request for support from a user only when the user's skill level is above a predetermined level, or it may recommend that the user receive some instruction when the user makes a support request and accept the request if the user still requests support.

Based on what has been thus far described, the embodiment of the present invention will be described more specifically.

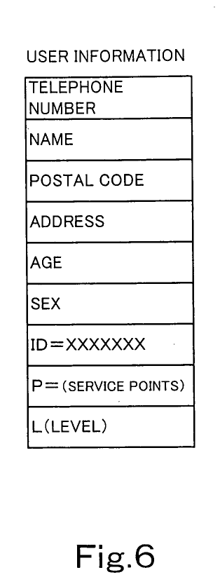

FIG. 6 shows an example of user information.

The user information is stored in the management database 100a shown in FIG. 1, including information such as a telephone number and a name that identifies a user operating the user machine 200, a user ID, current service point P that the user has obtained and has not consumed yet, and level L that indicates the user's skill level on the user machine 200.

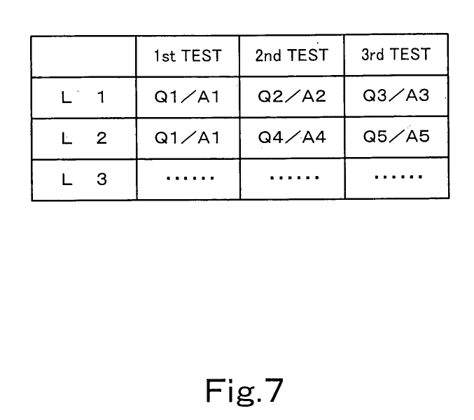

FIG. 7 generally shows the examination DB 100d shown in FIG. 1.

As shown, a Q (question) and A (answer) is stored for each of the levels L1, L2, L3 . . . , and for each of the first, second, third, . . . , test. The levels L1, L2, and L3 correspond to 1, 2, and 3 of the level L. The greater the level L value is, the higher the level is.

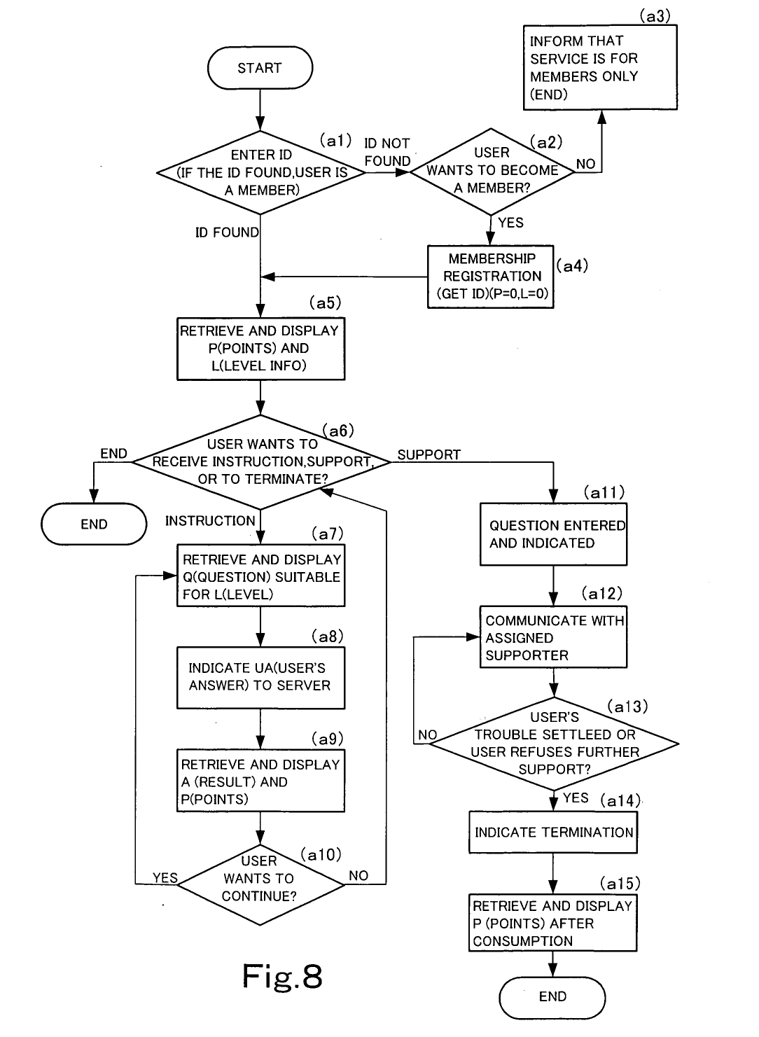

FIG. 8 illustrates an operational flow of the user machine.

Here, a user ID is entered into the user machine through a user operation (step a).

If the user ID entered has been already registered as user information in the management database 100a, the user is a member of the service system, and the process proceeds to step a5. If the user ID is not found, the user is asked whether or not he/she will become a member (step a2), and if the user makes an operation indicating that the user has no intension of becoming a member, the user is informed that the service is available only to its members and the process terminates (step a3).

Meanwhile, if the user will become a member, the user makes membership registration and obtains a user ID (step a4) The point P for the user at this point is zero and the user's skill level is evaluated as L=0, the lowest level.

At step a5, the user machine retrieves the user's point P and level L from the server machine and displays them, and, at step s6, an inquiry is displayed that asks the user whether he/she wants to receive instruction, receive support, or to terminate.

If the user selects to receive instruction, the process proceeds to step a7, where the user machine retrieves a Q (question) (see FIG. 7) appropriate for the user's current level L from the server machine and displays it, and, after an answer to the question Q (user's answer or “UA”) is entered by the user, the UA (user's answer) is indicated to the server machine. As will be described later, on receiving the UA, the server machine evaluates whether the UA is the correct answer to that Q (question), and updates the user's point P and level L in accordance with the evaluation. On the user machine, at step a9, A (whether the user's answer is correct or not, and the correct answer when the answer is wrong), P (point), and L (level) are retrieved and displayed. At step s10, the user is asked if he/she will continue to receive instruction, and if the user selects to continue, the process returns to step s7, where the next Q (question) is retrieved and displayed. If the user wants to end the instruction, the process returns to step a6.

Meanwhile, if the user selects to receive support at step a6, the process proceeds to step all, where a question is entered to the user machine through a user operation and the entered question is indicated to the server machine. Upon receiving the question, the server machine assigns the question to a supporter machine, and the user machine communicates with the supporter who operates the supporter machine assigned the question (step a12). If the user's problem is settled or the user refuses to receive further support (step a13), termination is indicated to the server machine (step a14), and the user's P (point) after being consumed for this time's support is retrieved and displayed (step a15).

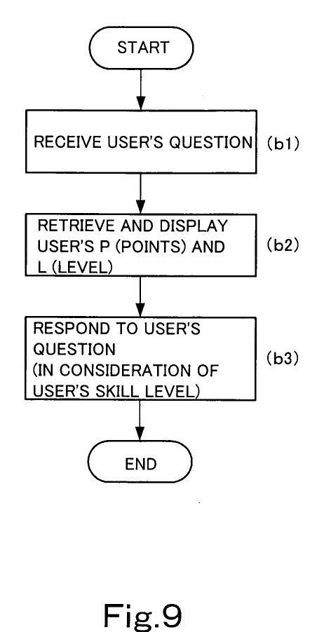

FIG. 9 shows an operational flow of the supporter machine.

Here, the user's question is received via the server machine (step b1), the user's P (point) and L (level) are retrieved and displayed (step b2), and then, a response to the user's question is given in accordance with the supporter's operation (step b3) . Here, the supporter gives an answer appropriate for the user checking the user's skill level.

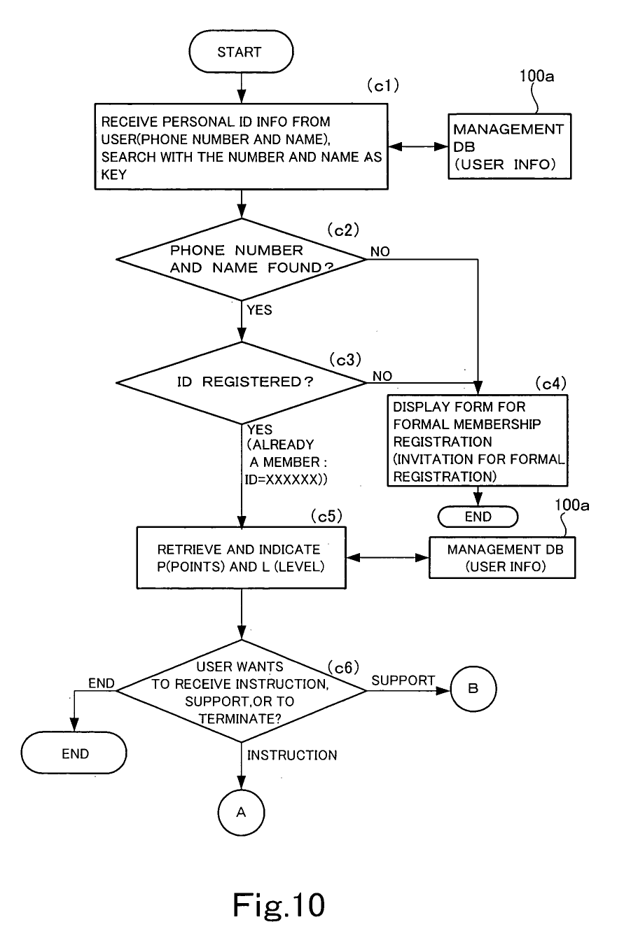

FIGS. 10 to 12 show an operational flow of the server machine.

First, personal identification information for a user is received from the user (user machine) (step c1). Here, the user's telephone number and name are received and the management DB 100a is searched with the telephone number and name as the key.

Determination is made as to whether or not user information that has the telephone number and name exists in the management DB 100a (step c2), and if it exists, it is further determined whether or not the user's ID has been registered (step c3). It may be a case with a user who has previously made provisional registration and the like that the telephone number and name are registered but the user ID is not registered.

If user information with the telephone number and the name does not exist in the management DB 100a, or if user information exists but the user ID is not registered, a form for formal membership registration is sent to the user machine and displayed so as to invite the user to become a formal member (step c4).

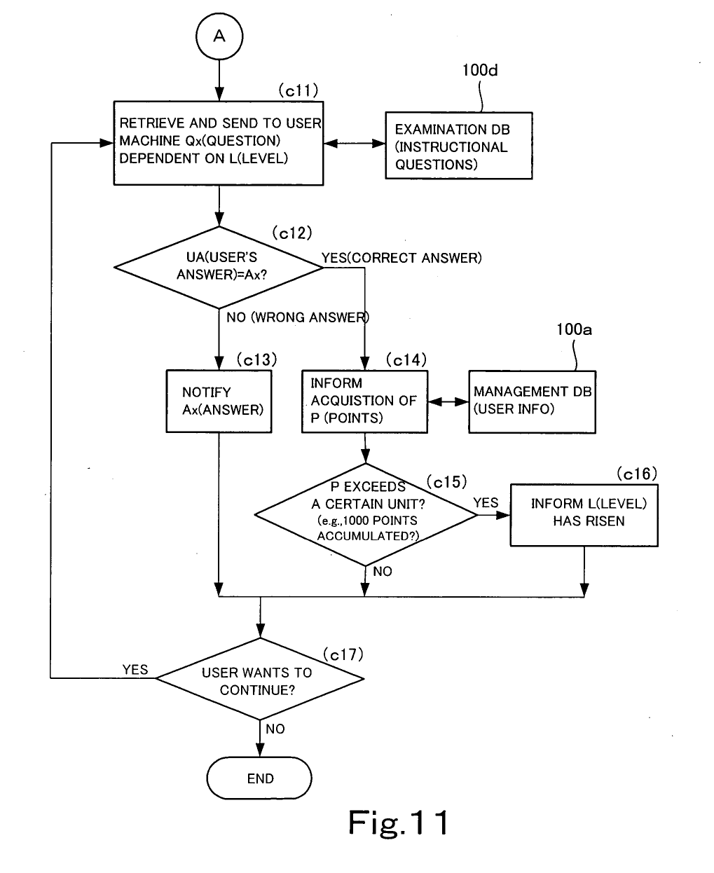

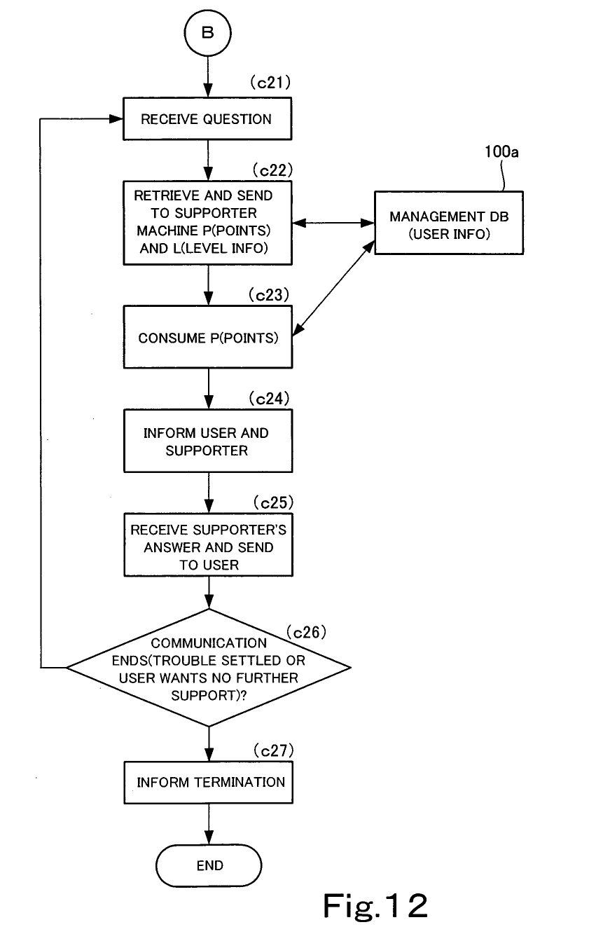

If the user ID has been already registered, the user is already a formal member of the service system, and the user's P (point) and L (level) are retrieved from the management DB 100a and indicated to the user's user machine (step c5), and indication that the user wants to continue the instruction or receive support, or that the user wants to terminate is received from the user machine. If it is indicated that the user wants to terminate, the process terminates. If it is indicated that the user wants to receive instruction, the process proceeds to the instruction flow shown in FIG. 11, and if the user wants to receive support, the process proceeds to the support flow shown in FIG. 12 (step c6).

If it is indicated that the user wants to receive instruction, the process proceeds to the flow of FIG. 11, where a Qx (question) appropriate for the user's skill level is retrieved from the examination DB 100d and sent to the user machine (step c11), and on receiving a UA (user's answer) from the user machine, it is determined whether or not the UA is the correct answer to the question (step c12). If the answer is wrong, Ax (the correct answer) is indicated to the user machine (step c13), and if the UA is correct, the user is informed that the user has got new P (points) and the points stored in the user information for the user in the management DB 100a (see FIG. 6) is updated (step c14). The points given to the user for making a correct answer may be predetermined points (100 points, for example) for one correct answer. Then, it is determined whether or not the user's P (points) inclusive of the new points exceeds a certain unit (1000 points, for example) (step c15), and if the P (points) exceeds the unit, the user machine is notified that the user's L (level) has risen (step c16). If the user wants to continue to receive instruction (step c17), the process returns to step c11, where the next question that depends on the user's L (level) is retrieved and sent to the user machine.

If it is determined that the indication from the user shows that the user wants to receive support at step c6 of FIG. 10, the process proceeds to the flow of FIG. 12, in which a question is first accepted from the user machine (step c21), and the user's P (points) and L (level) are retrieved from the management DB 100a and sent to a supporter machine along with the question (step c22). P (points) consumed for the question is subtracted from the user's points in the user information (step c23), and the user and the supporter are informed of the result (step c24). And the supporter machine sends an answer from the supporter to the user's question to the user machine (step c25). The points subtracted for a question may be predetermined points (100 points, for example) for one question.

If communication between the user and the supporter further continues, the process returns to step c21 to accept the next question, and when the communication ends, the supporter machine is informed of the termination (step c27)

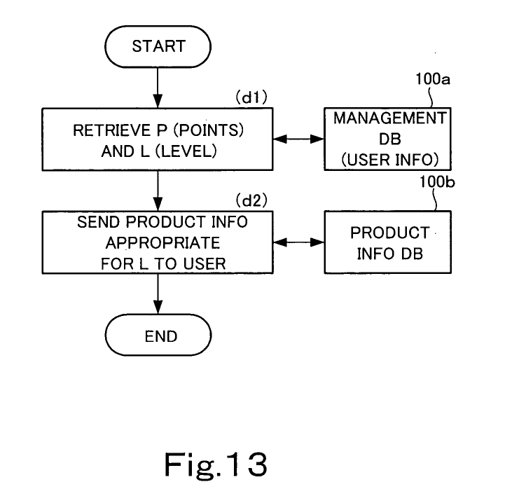

FIG. 13 illustrates an operational flow of suggesting products to a user machine by the server machine.

Here, the P (points) and L (level) for a user to whom products are to be suggested are retrieved from the management DB 100a (step d1), and product information appropriate for the user's L (level) is retrieved from the product information DB 100b and sent to the user's user machine (step d2). This allows products suitable for the user to be suggested. In suggesting products to a user, the user is also informed that discount service is available in exchange for the user's points if it has accumulated.

Although not shown as a flow, if the user requests that a Q&A be sent, a Q&A appropriate for the user's skill level is retrieved from the Q&A DB 100c of FIG. 1 and sent to the user's user machine.

Thus, products and Q&A appropriate for the user's skill level are suggested and sent by considering the user's skill level.

Now, another specific embodiment will be described. While the embodiment described with respect to FIGS. 6 to 13 determines each user s skill level as a single level, the embodiment described below is an embodiment of a type that evaluates a user's skill level separately for different fields (categories) about the user machine (e.g., classified as categories of hardware, operating system (OS), individual application programs).

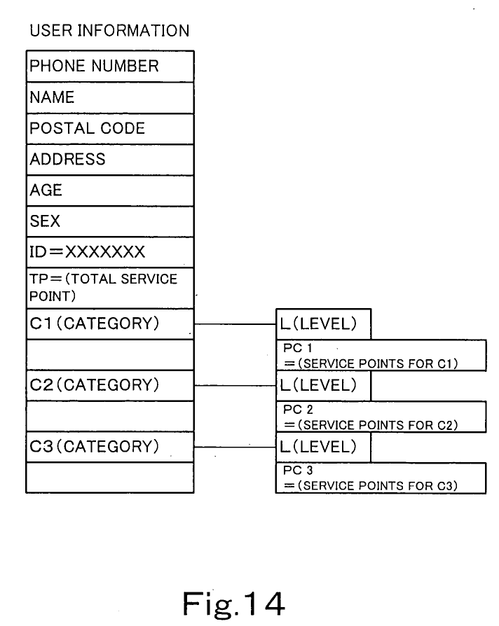

FIG. 14 shows an example of user information, corresponding to FIG. 6 for the embodiment above.

The user information is stored in the management database 100a shown in FIG. 1, including information such as a telephone number and a name identifying a user who operates the user machine 200, a user ID, remaining TP (total service point) that the user has acquired and has not consumed yet, each field (category) of the user machine 200, level L that indicates the user's skill level for each category, and PC (service point) for each category.

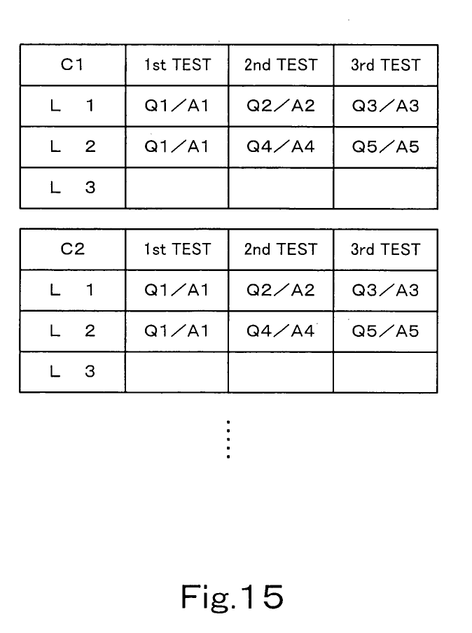

FIG. 15 generally shows the examination DB 100d of FIG. 1, corresponding to FIG. 7 for the embodiment described above.

As shown, separately for each field (category) C1, C2, . . . , a Q (question) and A (answer) is stored for each level L1, L2, . . . , and L3 for each of the first, second, third, . . . , test. As described above in connection with FIG. 7, level L of a greater value signifies a higher level.

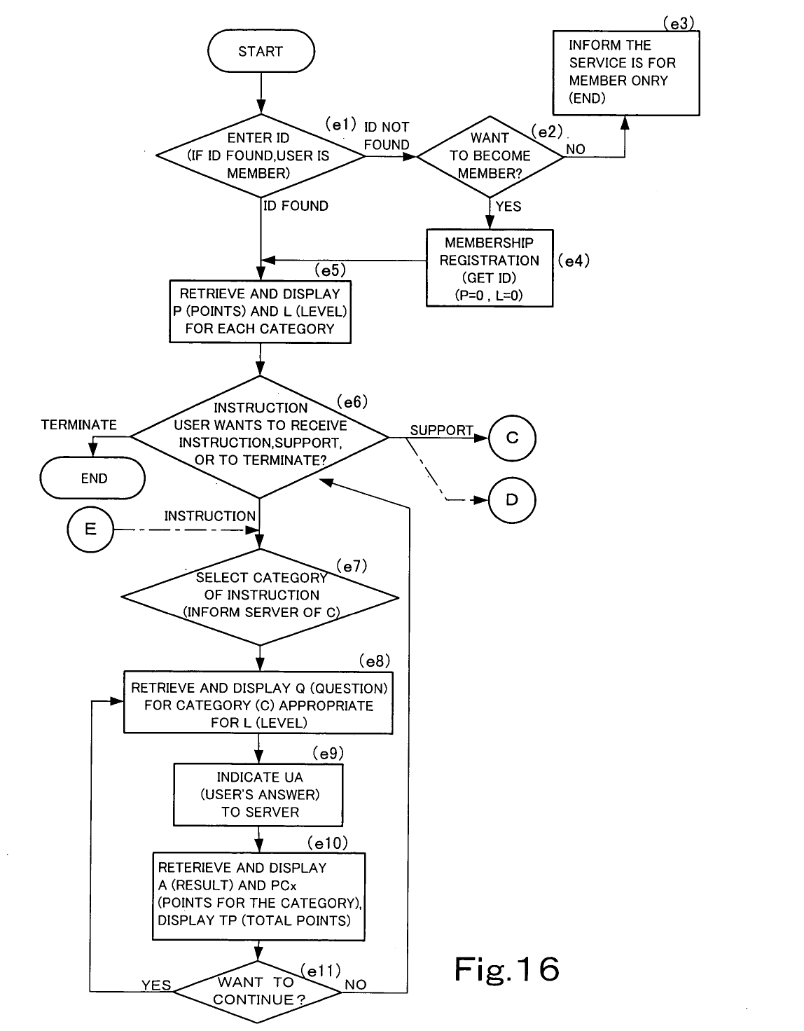

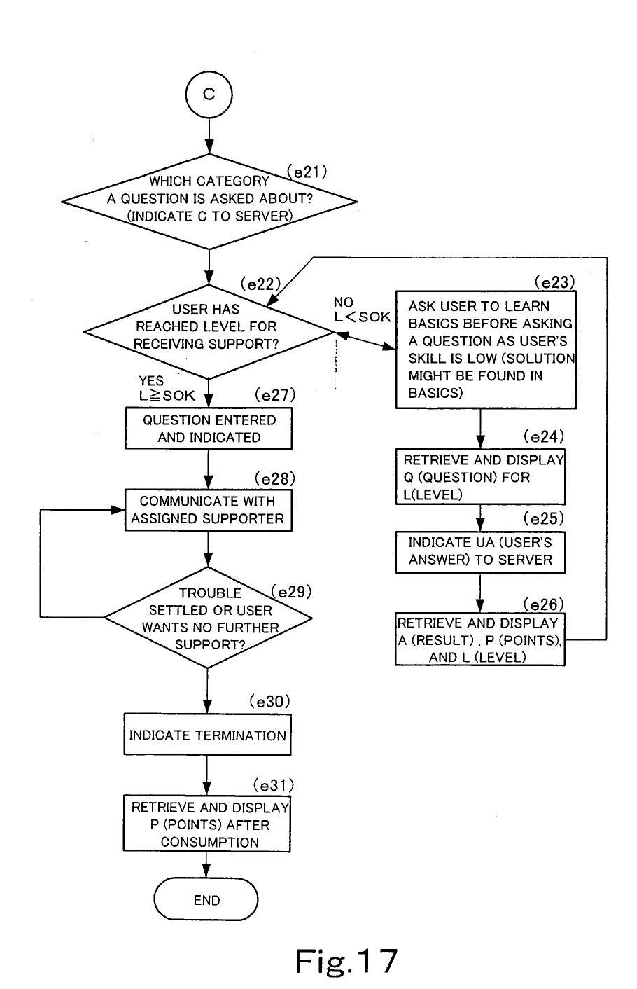

FIGS. 16 and 17 show an operational flow of the user machine.

Here, a user ID is entered to the user machine through a user operation (step e1).

If the entered user ID has been already registered as user information in the management database 100a, the user is a member of the service system and the process proceeds to step e5. If the user ID is not found, the user is asked whether or not the user will become a member of the service system (step e2), and if the user makes an operation indicating that the user has no intention of becoming a member, the user is informed that the service is available only to its members and the process terminates (step e3).

If the user has the will of becoming a member, the user makes membership registration and gets a user ID (step e4). The user's points P at this point are zero for all the categories and the skill levels are evaluated as L=0, the lowest level, for all the categories.

At step e5, the user machine retrieves the user's points P and level L for individual categories from the server machine and displays them, and, at step e6, an inquiry is displayed that asks the user whether he/she wants to receive instruction, receive support, or to terminate.

If the user selects to receive instruction, the process proceeds to step e7, where the category of instruction the user is going to receive is selected by the user, the selected category is indicated to the server machine, and a Q (question) (see FIG. 7) on the selected category appropriate for the user's current skill level L is retrieved from the server machine and displayed (step e8). And after an answer to the Q (question) (user's answer or UA) is entered by the user, the UA (user's answer) is indicated to the server machine (step e9) As will be described later, in response to the indication of the UA, the server machine evaluates whether or not the UA is the correct answer to that Q (question), and updates the user's points P and level L for that category in accordance with the evaluation. At step e10, the user machine retrieves and displays A (whether the answer is correct, and the correct answer when the answer is wrong), P (points) and L (level) for the category, as well as TP (total points) that sums points for all the categories for the user. At step e11, the user is inquired whether he/she will continue to receive instruction, and if the user selects to continue, the process returns to step e8, where the next Q (question) is retrieved and displayed. If the user selects to terminate the instruction, the process returns to step e6.

If the user selects to receive support at step e6, the process proceeds to step e21 of the flow shown in FIG. 17, in which a category about which the user is going to ask a question is entered by the user and that category C is indicated to the server machine. Then, at the following step e22, determination is made as to whether or not the user has reached a level that permits the user to receive support on the category C. Here, SOK indicates the minimum level at which user can receive support, defined for each category.

If the user's level L for that category is below the support permitting level SOK for that category, the process proceeds to step e23, where the user is informed that he/she should learn basic skills before asking a question because his/her level is too low and that he/she can often find a solution to the problem for which the user is going to receive support in the course of learning basic skills.

Then, a question appropriate for the user's level L in the category is retrieved from the server machine and displayed (step e24), input of an answer by the user is accepted and the US (user's answer) is indicated to the server machine (step e25), and A (the correct answer when the UA is wrong) and the point P and level L for that category are retrieved and displayed (step e26) . While the user's level L for that category remains L<SOK, the steps e23 through e26 are repeated.

If it is determined at step e22 that the user's level L for the category has reached the minimum level SOK (i.e., L≧SOK) that permits utilization of support, the user is permitted to enter a question to a supporter, and at step e27, a question is entered to the user machine through a user operation and the question is indicated to the server machine. On receiving the question, the server machine assigns the question to a supporter machine, and the user machine communicates with the supporter who operates the supporter machine (step e28). If the user's problem is settled or the user refuses to take further support (step e29), the server machine is informed of termination (step e30), and the user's P (points) after being consumed for this time's support is retrieved and displayed (step e31). The remaining point for the category of the question is to be decreased, and the points subtracted for a question may be predetermined points (100 points, for example) for one question.

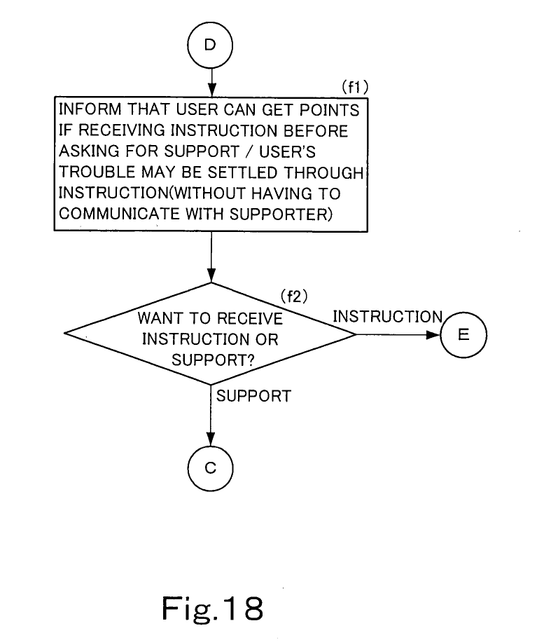

In the operational flow of the user machine described with reference to FIGS. 16 and 17, the user is allowed to freely select either to receive instruction or receive support at step e6 of FIG. 16 but is forced to receive instruction if the user has not reached a level that receives support at step e22 of FIG. 17. The user machine may alternatively be configured to force the user to first receive instruction irrespective of his/her skill level when the user selects to receive support, and allow the user to receive support after completing the instruction. Alternatively, the user machine may be configured to invite the user to receive instruction but permit the user to receive support even if the user does not receive instruction, as in a variation of FIG. 18 to be described below.

FIG. 18 illustrates differences of a variation of the operational flow of the user machine described with FIGS. 16 and 17 from the flow of FIGS. 16 and 17.

If the user selects to receive support at step e6 of FIG. 16, the process proceeds to step f1 of FIG. 18, where the user is informed that he/she can get some points if he/she receives instruction before receiving support and that the user's problem can often be solved through the instruction so that the user do not have to communicate with a supporter. Then, at step f2, the user is again made to select either to receive instruction or still receive support without receiving any instruction. If the user selects to receive instruction at this point, the process proceeds to step e7 of FIG. 16, and if the user still selects to receive support, the process proceeds to step e21 of FIG. 17. Here, steps e22 through e26 are essentially omitted and step e21 directly leads to step e27. However, steps e22 to e26 may alternatively remain and the SOK level may be set to a quite low level so that a user of such a low level that is below even that level of SOK may be forced to receive instruction.

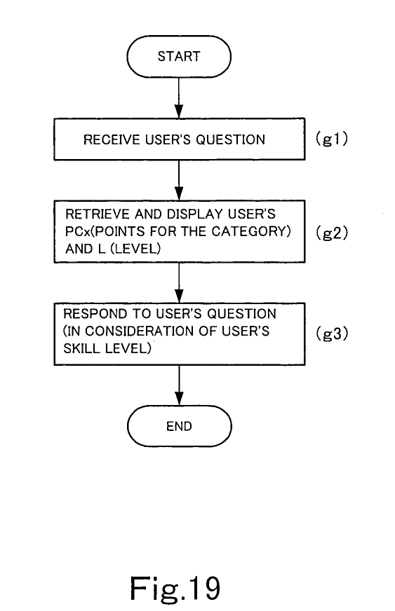

FIG. 19 shows an operational flow of the supporter machine.

In this flow, a user's question is received via the server machine (step g1), the user's PCx (point) and L (level) for the category of the question are retrieved and displayed (step g2), and thereafter, a response is given to the user's question in accordance with the supporter's operations (step g3). Here, the supporter gives an answer appropriate for the user's skill level checking the user's skill level.

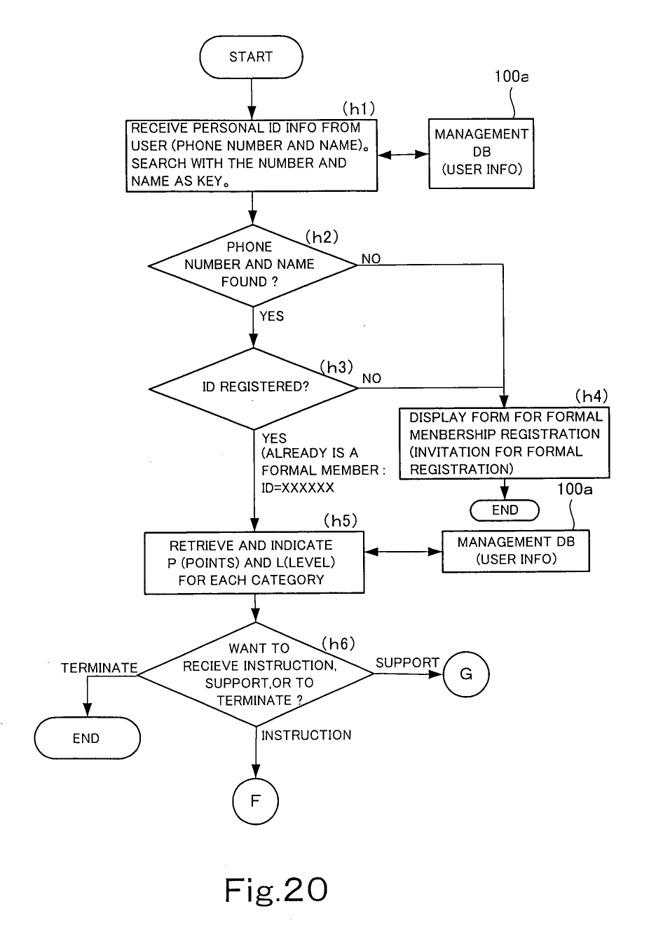

FIGS. 20 to 22 show an operational flow of the server machine.

First, personal identification information for the user is received from the user (user machine) (step hi). Here, the user's telephone number and name are received and the management DB 100a is searched with the telephone number and the name as the key.

Determination is made as to whether or not user information that has the telephone number and name exists in the management DB 100a (step h2), and if it exists, it is further determined whether or not the user's ID has been registered (step h3).

If user information with the telephone number and the name does not exist in the management DB 100a, or if user information exists but the user ID is not registered, a form for formal membership registration is sent to the user machine and displayed so as to invite the user to become a formal member (step h4).

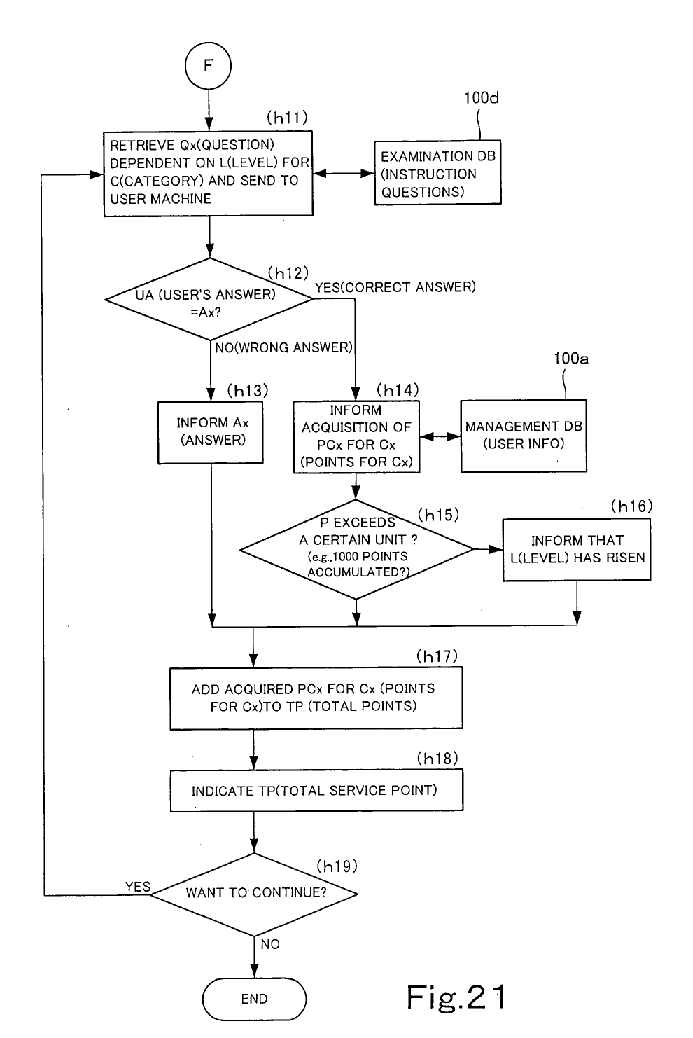

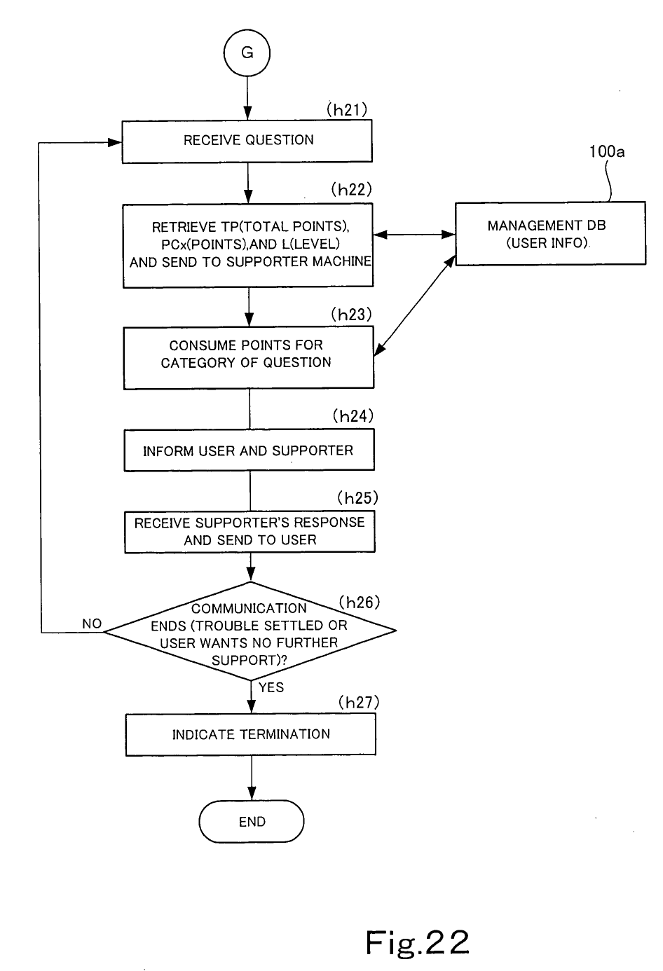

If the user ID has been already registered, the user is already a member of the service system, and the user's P (points) and L (level) for individual categories are retrieved from the management DB 100a and indicated to the user's user machine (step h5). In response to an indication from the user machine that the user wants to receive instruction or support or that the user wants to terminate, if the user wants to terminate, the process terminates without further operation, and if the user wants to receive instruction, the process proceeds to the instructional flow shown in FIG. 21, and if the user wants to receive support, the process proceeds to the support flow shown in FIG. 22 (step h6).

If it is indicated that the user wants to receive instruction, the process proceeds to the flow of FIG. 21, in which Qx (question) appropriate for the user's level L on that category C is retrieved from the examination DB 100d and sent to the user machine (step h11). On receiving a UA (user's answer) from the user machine, determination is made as to whether or not the UA is the correct answer to the question (step h12), and if the UA is wrong, the correct answer is indicated to the user machine (step h13) . If the UA is correct, the user is informed that the user has newly got PCx (points) for the category Cx, and the points stored in the user information for that user in the management DB 100a (see FIG. 14) is updated (step h14). Further, determination is made as to whether or not the P (points) has exceeded a certain unit (1000 points, for example) (step h15), and if P (points) exceeds the unit, the user machine is informed that the user's L (level) for that category has risen (step h16). And the newly acquired points PCx for the category Cx is added to the total points TP (step h17) and the total points TP is also indicated to the user machine (step h18). Points given to the user for answering correctly may be predetermined points (100 points, for example) for one correct answer.

If the user wants to receive further instruction (step h19), the process returns to step h11, where the next question that depends on the user's level L for the category C is retrieved and sent to the user machine.

At step h6 of FIG. 20, if it is determined that the user's indication shows the user wants to receive support, the process proceeds to the flow of FIG. 22, in which the user's question is first received from the user machine (step h21), and the user's total points TP, points PCx for each category, and levels L for individual categories are retrieved from the management DB 100a and sent to a supporter machine with the question (step h22), points consumed for the question is subtracted from the points PCx for the category of the user's question in the user information (step h23), and the result is indicated to the user and the supporter (step h24). And the supporter machine sends an answer from the supporter to the user's question to the user machine (step h25) . Points subtracted for a question may be predetermined points (100 points, for example) for one question.

If communication between the user and the supporter further continues, the process returns to step h21 to receive the next question, and when the communication ends, the supporter machine is informed of the termination (step h27) If the remaining points for the category of the user's question is less than the points to be consumed for the next question, the user machine may be informed that a question about that category cannot be accepted. In the case the total points exceeds the points to be subtracted, not only the remaining points for the category but remaining points for another category may be decreased. (That category may be selected by the user, or determined by the user machine in a predetermined order.)

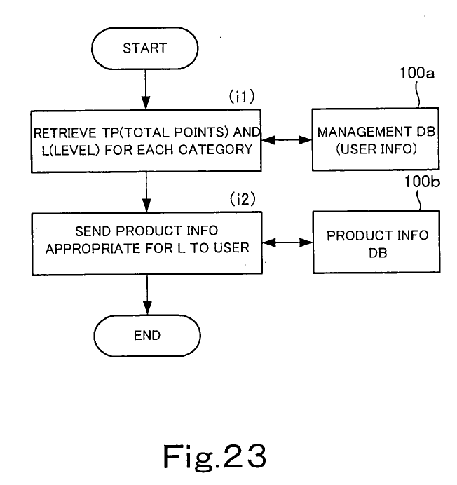

FIG. 23 shows an operational flow of suggesting products to a user machine.

The total points TP and levels L for individual categories of a user to whom products are to be suggested are retrieved from the management DB 100a (step d1), and product information corresponding to each of the categories appropriate for the user's levels L for each of the categories is retrieved from the product information DB 100b and sent to the user's user machine (step i2) . This allows products appropriate for the user's skill levels for each category to be suggested.

In suggesting products to a user, the user is also informed that discount service is available in exchange for consuming the user's total points TP if it has accumulated.

Although not shown as a flow as in the embodiment described earlier either, if the user requests that Q&As be sent, a Q&A on each category appropriate for the user's skill level for each category is retrieved from the Q&A DB 100c of FIG. 1 and sent to the user's user machine.

As has been described, in the present embodiment, the user's skill level is determined for each category so that products and Q&As appropriate for the user's skill level can be suggested and sent.

While in the embodiments above no specific reference has been made as to the category of an object of support, the object of support may be the hardware of a user machine, software running on a user machine, all of the hardware and software, or a portion of them (e.g., an optical disk drive when the user machine is equipped with one, or only a particular application program running on the user machine).

In addition, while in the embodiments the server machine 100 operating as the user support management apparatus of the present invention manages support relating to the user machine 200 connected thereto via a communication line, it may manage support for a user machine that is not connected by a communication line such as by obtaining a user's skill level via a portable medium (e.g., a flexible disk, CD-R/RW etc.), for example.

1. A user support management apparatus, characterized in comprising:
a user information acquisition section that obtains the skill level of a user with respect to an object of support; and
a user information storage section that stores skill level obtained by the user information acquisition section in association with the user.

2. The user support management apparatus according to claim 1, wherein the user information acquisition section obtains skill level that is evaluated based on the result of instruction on the object of support received by the user.

3. The user support management apparatus according to claim 1, wherein the user information acquisition section receives the result of instruction on the object of support received by the user and evaluates the skill level of the user based on the result so as to obtain the user's skill level.

4. The user support management apparatus according to claim 3, wherein the user information acquisition section sends instructional material on an object of support to the object of support employed by the user and receives the result of instruction received by the user with the instructional material.

5. The user support management apparatus according to claim 1, wherein the user information acquisition section sends to an object of support both instructional material on the object of support and a scheme that evaluates the result of instruction with the instructional material to determine the skill level of a user, and receives the skill level of the user that has been determined in the object of support based on the result of instruction received by the user with the instructional material.

6. The user support management apparatus according to claim 1, wherein the user information acquisition section obtains skill level for separate fields on an object of support, and the user information storage section stores skill level for separate fields obtained by the user information acquisition section in association with a user.

7. The user support management apparatus according to claim 1, wherein the user information acquisition section causes the user information storage section to store obtained skill level in association with the user, obtains points newly acquired by the user and adds the points to the remaining points of the user, and causes the user information storage section to store the total points in association with the user, and wherein the user information acquisition section obtains information on point consumption and updates the points stored in the user information storage section of the user who has consumed points to points that is decreased by the consumed points.

8. The user support management apparatus according to claim 7, wherein the user information acquisition section obtains points that a user has acquired in accordance with the result of instruction on an object of support received by the user.

9. The user support management apparatus according to claim 7, wherein the user information acquisition section receives the result of instruction on the object of support received by a user and calculates points acquired by the user based on the result so as to obtain the user's acquired points.

10. The user support management apparatus according to claim 9, wherein the user information acquisition section sends to an object of support instructional material on the object of support and receives the result of instruction received by the user of the object of support with the instructional material.

11. The user support management apparatus according to claim 7, wherein the user information acquisition section sends to an object of support both instructional material on the object of support and a scheme that calculates acquired points based on the result of instruction with the instructional material, and receives points acquired by the user that has been calculated in the object of support based on the result of instruction received by the user of the object of support with the instructional material.

12. The user support management apparatus according to claim 1, comprising an information provision section that provides an object of support with information appropriate for the skill level of a user of the object of support.

13. The user support management apparatus according to claim 1, comprising a support request accepting section that accepts a request for support from a user and indicates the acceptance of the support request to a supporter machine operated by a supporter responsible for user support along with information on the skill level of the requesting user.

14. The user support management apparatus according to claim 13, wherein the user support request accepting section accepts a support request from a user only when the user's skill level is above a predetermined skill level.

15. The user support management apparatus according to claim 13, wherein the support request accepting section recommends to a user to receive instruction when the user makes a support request and accepts the request if the user still requests support.

16. A user support management program storage medium storing a user support management program that is executed in an information processing apparatus executing programs and causes the information processing apparatus to operate as a user support management apparatus that comprises:
a user information acquisition section that obtains the skill level of a user for an object of support; and
a user information storage section that stores skill level obtained by the user information acquisition section in association with the user.

17. The user support management program storage medium according to claim 16, wherein the user information acquisition section obtains skill level that is evaluated based on the result of instruction on the object of support received by the user.

18. The user support management program storage medium according to claim 16, wherein the user information acquisition section receives the result of instruction on the object of support received by the user and evaluates the skill level of the user based on the result so as to obtain the user's skill level.

19. The user support management program storage medium according to claim 18, wherein the user information acquisition section sends instructional material on an object of support to the object of support employed by a user and receives the result of instruction received by the user of the object of support with the instructional material.

20. The user support management program storage medium according to claim 16, wherein the user information acquisition section sends to an object of support both instructional material on the object of support and a scheme that evaluates the result of instruction with the instructional material to determine the skill level of a user, and receives the skill level of the user that has been determined in the object of support based on the result of instruction received by the user of the object of support with the instructional material.

21. The user support management program storage medium according to claim 16, wherein the user information acquisition section obtains skill level for separate fields on an object of support, and the user information storage section stores skill level for separate fields obtained by the user information acquisition section in association with a user.

22. The user support management program storage medium according to claim 16, wherein the user information acquisition section causes the user information storage section to store obtained skill level in association with the user, obtains points newly acquired by the user and adds the points to the remaining points of the user, and causes the user information storage section to store the total points in association with the user, and wherein the user information acquisition section obtains information on point consumption and updates the points stored in the user information storage section of the user who has consumed points to points that is decreased by the consumed points.

23. The user support management program storage medium according to claim 22, wherein the user information acquisition section obtains points that a user has acquired in accordance with the result of instruction on an object of support received by the user.

24. The user support management program storage medium according to claim 22, wherein the user information acquisition section receives the result of instruction on the object of support received by a user and calculates points acquired by the user based on the result so as to obtain the user's acquired points.

25. The user support management program storage medium according to claim 24, wherein the user information acquisition section sends to an object of support instructional material on the object of support and receives the result of instruction received by the user of the object of support with the instructional material.

26. The user support management program storage medium according to claim 22, wherein the user information acquisition section sends to an object of support both instructional material on the object of support and a scheme that calculates acquired points based on the result of instruction with the instructional material, and receives points acquired by the user that has been calculated in the object of support based on the result of instruction received by the user of the object of support with the instructional material.

27. The user support management program storage medium according to claim 16, causing the information processing apparatus to further operate as a user support management apparatus that comprises an information provision section that provides an object of support with information appropriate for the skill level of a user of the object of support.

28. The user support management program storage medium according to claim 16, causing the information processing apparatus to further operate as a user support management apparatus that comprises a support request accepting section that accepts a request for support from a user and indicates the acceptance of the support request to a supporter machine operated by a supporter responsible for user support along with information on the skill level of the requesting user.

29. The user support management program storage medium according to claim 28, wherein the user support request accepting section accepts a support request from a user only when the user's skill level is above a predetermined skill level.

30. The user support management program storage medium according to claim 28, wherein the support request accepting section recommends to a user to receive instruction when the user makes a support request and accepts the request if the user still requests support.

31. The user support management apparatus according to claim 1, being connected to a communication line and managing an object of support that is connected thereto via the communication line.

32. The user support management program storage medium according to claim 16, wherein the information processing apparatus is connected to a communication line and the user support management program causes the information processing apparatus to operate to manage an object of support that is connected to the information processing apparatus via the communication line.
